(19) United States
(12) Patent Application Publication
(10) Pub. No.: US 2010/0118655 A1
(43) Pub. Date: May 13, 2010

(54) Progressive 3D vertical seismic profiling method

(76) Inventors: Andres Chavarria, Los Angeles, CA (US); Martin Karrenbach, Brea, CA (US); William Bartling, Bakersfield, CA (US)

Correspondence Address: Gregory IPL, P.C., 601 W. Main Avenue, Suite 904, SPOKANE, WA, 99201-3825, US

(21) Appl. No.: 12/291,361

(22) Filed: Nov. 8, 2008

(51) Int. Cl. G01V 1/28

(52) U.S. Cl. 367/57

(57) ABSTRACT

A method includes providing a first data set representative of a first 3D VSP of a first region of a subterranean formation, and providing a second data set representative of a second 3D VSP of a second region of the subterranean formation. The first data set and the second data set define a common region of the subterranean formation. The first data set and the second data set are merged within the common region to produce a third data set representative of a third 3D VSP of the first and second regions of subterranean formation. The third data set is then stored on a computer readable medium.

### BACKGROUND

Three dimensional vertical seismic profiling (3D VSP) is a seismic imaging method used to provide high resolution imaging of a region of a subterranean formation, and is typically used to image petroleum reservoirs, but can also be used for imaging and monitoring CO₂ sequestration, mining assets, geothermal prospecting, earthquake hazard management or any other purpose which would benefit from high resolution imaging of the subsurface of the earth. 3D VSP differs from surface seismic imaging in that during 3D VSP data collection one of the source or the receiver (typically, the receiver) is placed in a borehole in the formation, rather than having the source and receiver both located at the surface. Commonly, a string of geophones or other sensing devices, which act collectively as a receiver array, are placed within a borehole during 3D VSP data acquisition. The source, ordinarily dynamite or vibroseis, can be located at the surface, or in vibrator in another borehole (in which case the imaging is known as cross-well 3D VSP, also known as cross-well tomography). In the case of an offshore (subsea) reservoir, the source is commonly an air gun placed in the water at or near the surface of the water.

The receiver or receivers in the borehole receive seismic energy produced by the source. The seismic energy arrives at the source as direct arrivals, as reflected upgoing waves, and as direct arrival and reflected downgoing waves. The receiver converts the detected energy into signals which are then transmitted to a data collection location. The signals are typically converted from analog signals to digital signals. The set of digital signals form a vertical seismic profile (3D VSP) data set representative of a region of the formation. This unprocessed 3D VSP data can then be processed using known processing techniques to produce a model of the region, which can be stored on computer readable medium as a 3D VSP image data. The 3D VSP image data can be used to generate visual images of the region, and can also be used for computer simulations and the like. Frequently 3D VSP data is augmented with data from a surface seismic survey to produce a higher quality image of a portion of the formation. The seismic image is generated as a result of interaction (reflections, mostly) between the seismic energy from the source and geological structures within the subterranean formation, as well as traveltime of the signals from the source to the receiver (directly or indirectly). An example of a subterranean structure is a geological feature such as a dip, a fold, or a transition from one rock type to another (e.g., from sandstone to granite). A subterranean event can include not only geological features, but also a lateral change in physical properties (e.g., density, porosity, temperature, fluid content, etc.) within the same rock strata. Traveltime is also affected by changes in physical properties, often but not exclusively as a function of depth. A 3D VSP image is expressed either as a cone or a cylinder representing that part of the subterranean area that is imaged by the survey.

### BRIEF DESCRIPTION OF THE DRAWINGS

FIG. 1 is an oblique schematic diagram depicting a portion of a subterranean formation wherein a geophone array has been placed for recording a 3D VSP.

FIG. 2 is an isometric schematic diagram depicting two adjacent and overlapping cylindrical regions of a subterranean formation which can be imaged using 3D vertical seismic profiling.

FIG. 3 is a schematic plan view depicting a plurality of cylindrical regions of a subterranean formation which can be imaged using 3D vertical seismic profiling and thereafter combined to provide a combined 3D VSP regional view of the formation.

FIGS. 4A and 4B together are a flowchart depicting a first embodiment of the method for merging 3D VSP data sets.

FIG. 5 is a schematic diagram depicting graphical representations of two 3D VSP data sets.

FIG. 6 is a flowchart depicting a second embodiment of the method for merging 3D VSP data sets.

### DETAILED DESCRIPTION

The methods described herein include performing processing steps on a plurality of 3D VSP data sets in order to merge the 3D VSP data sets in one or more common regions. Throughout the discussion we will describe performing a first processing step on a 3D VSP data set, performing a second processing step on the 3D VSP data set, and so on. It will be understood that in this instance the 3D VSP data set is intended to be an evolutionary data set, and not the original data set. For example, if the method describes performing a first processing step on a 3D VSP data set, and thereafter performing a second processing step on the 3D VSP data set, it is understood that the second processing step is performed on the data set that includes the results of the first processing step. If we intend that a subsequent processing step should be performed on the original 3D VSP data set (i.e., on a data set that does not including the results of previous processing steps), we will explicitly state so.

The methods described herein can be performed using computers and data processors. The data described herein can be stored on computer-readable media. Furthermore, the methods described herein can be reduced to a set of computer readable instructions capable of being executed by a computer processor, and which can be stored on computer readable media.

Overview

The methods described herein provide for merging a plurality of 3D vertical seismic profile (3D VSP) data sets representative of regions of a subterranean formation. In the methods, at least two 3D VSP data sets are combined, wherein the two 3D VSP data sets describe a contiguous region of the formation with a prescribed amount of overlap between the two or more surveys of common region of the formation. The methods allow for a subterranean formation to be more thoroughly imaged by combining 3D VSP data over large volumes of the formation comparable in size and coverage to conventional 3D surface seismic surveys, however with much higher vertical and lateral resolution and frequency content. Further, the combined 3D VSP data can be augmented with surface seismic data over the same combined volumes to provide an enhanced image of the formation.

When the 3D VSP data sets of the different overlapping adjacent regions are collected at different times, then the combined 3D VSP data set can provide an evolutionary image of the formation in the combined regions. Such is useful in the field of petroleum production in a petroleum reservoir in a subterranean formation, as it provides information regarding changes to the reservoir over time as a result of petroleum production and other time-sensitive factors which can affect the qualities of the reservoir, and can thus provide the operator with information relevant to near-term investment decisions.

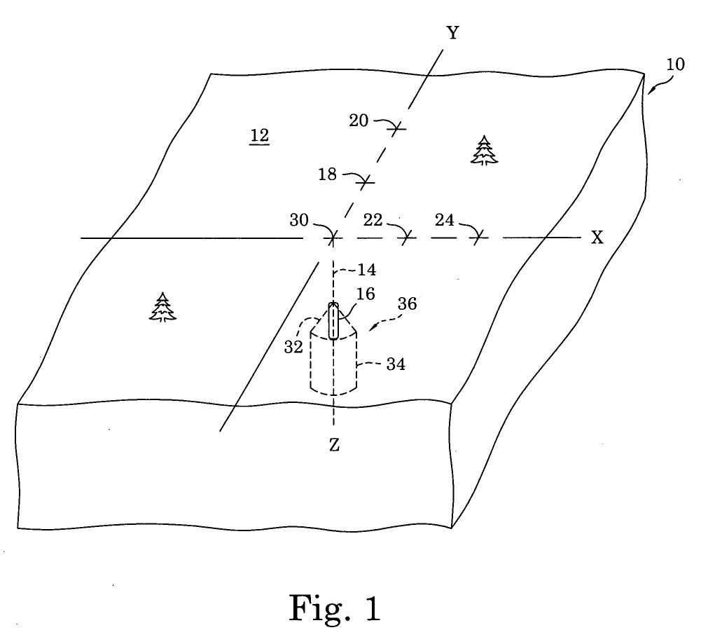

Turning to FIG. 1, a schematic diagram of a subterranean formation 10 is depicted in oblique view. The subterranean formation 10 is defined by an upper surface 12, which can be terra firma or, in the case of a subsea formation, the ocean floor. A borehole 14 is defined in the formation 10, initiating at a wellhead point 30 at the upper surface 12. For the sake of reference, Cartesian coordinates X, Y and Z are defined from the wellhead, with the Z-axis being in the direction of depth, and the X and Y-axes defining the horizontal. It will be appreciated that many boreholes are not essentially vertical, as depicted for borehole 14 in FIG. 1, but can in fact turn to thus slant on a substantial angle from the vertical. However, for purposes of the instant disclosure, the convention of a vertical well bore will be used for simplicity. Those of skill in the art will understand how to adapt the present methods when 3D VSP data is collected in boreholes that deviate from purely vertical.

Borehole 14 (the centerline only of which is depicted in FIG. 1) is shown as having placed therein a receiver array 16 (which is depicted in solid lines even though it is beneath the surface 12). Each receiver 22 in the array 14 can either contain a single recording element oriented parallel relative to the wellbore 12, or three recording elements mutually orthogonal to each other, one oriented parallel relative to the wellbore 12 and the other two transverse relative to the wellbore, and these two transverse elements oriented orthogonal to one another. The receiver array 16 is typically lowered into the wellbore 14 on a cable (not shown) which is supported by a production rig, crane or winch (also not shown) at the surface 12 (in the case of dry land). A seismic source (not specifically shown) can be placed at various locations 18, 20, 22, 24, etc. on the surface 12 to generate 3D VSP seismic data by passing seismic energy from the source to the receiver array 16, either directly (downgoing waves) or via reflections (upgoing waves for first reflection and downgoing waves for multiple reflections) off of structures and events in the formation 10. (It will be appreciated that in a 3D VSP survey seismic energy can exist as waves from secondary (and beyond) reflections, as well as from direct reflections and energy directly from the source.) The receiver array 16 thus receives seismic energy which is representative of a region 30 of the subterranean formation. Region 30 is a three dimensional volume defined by an upper cone 16 along the length of the receiver array 16, and a lower cylindrical portion 34 depending below the receiver array.

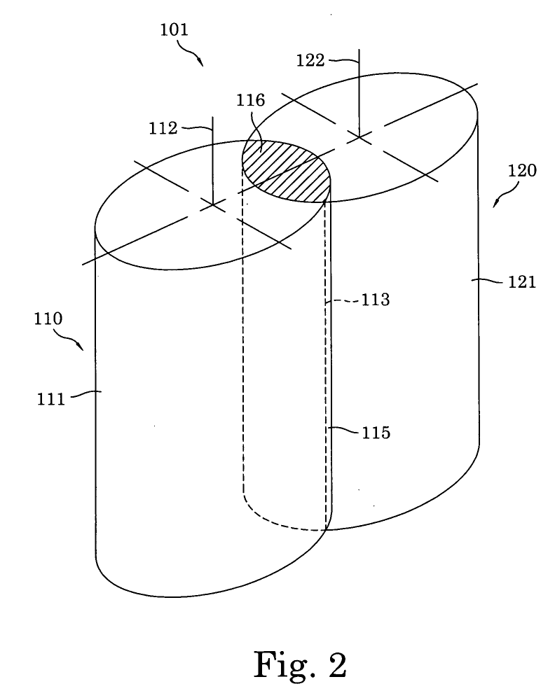

Turning now to FIG. 2, a schematic diagram depicts two adjacent and overlapping regions of a subterranean formation. A first region 110 is defined around a first wellbore (the wellhead of which is depicted as item 112), while a second region 120 is defined around a second wellbore (the wellhead of which is depicted as item 122). Regions 110 and 120 are adjacent to one another in that they share at least one common line 113 (but typically two common lines) where the regions abut. (While common line 113 is depicted in FIG. 2 as being a straight vertical line, this is not a requirement for defining regions 110 and 120 as being adjacent.) Regions 110 and 120 also overlap one another in a common region 115, which is bounded at an upper side 116 of the common region. While the first region 110 and the second region 120 are depicted in FIG. 2 as being essentially parallel in vertical geometry, and thus define a regular geometric common region 115 (being defined by opposing circular arcs along parallel vertical radii), this is not a requirement, and indeed the common region 30 can be defined by an irregular geometric shape.

The present disclosure provides for methods for combining a first 3D VSP data set representative of the first region 110 with a second 3D VSP data set representative of the second region 120 in order to provide a resultant third 3D VSP data set representative of the combined first and second regions (designated in FIG. 2 as item 101). It will thus be appreciated that the combined first and second regions 101 include not only the common region 115, but also a first exclusive region 111 which is exclusive to the first region 110 (in that it does not include any portion of the common region 115), and a second exclusive region 121 which is exclusive to the second region 120 (in that it also does not include any portion of the common region 115).

The methods disclosed herein provide for combining a first 3D VSP data set representative of the first region 110 with a second 3D VSP data set representative of the second region 120 in order to produce a 3D VSP data set representative of the combined first and second regions. Preferably, the methods respect and provide essential continuity from the first region 110 to the second region 120 across the common region 115. Particular methods for accomplishing this desirable continuity of 3D VSP data within the common region 115 between the first region 110 and the second region 120 are described more particularly below. In general, the methods described herein provide for managing the 3D VSP data in the common region 115 in order to produce an essentially continuous pattern between the first and second regions 110 and 120 in the common region 115.

FIG. 2 depicts only the cylindrical portions of the 3D VSP imaged first regions 110 and 120, while omitting the conical portion (32, FIG. 1) of each region. Frequently, the conical portions of adjacent regions do not share any common line where the regions abut throughout the respective conical regions. In the following disclosure, the discussion is particularly directed towards methods for generating a 3D VSP data set that uses common data from the first 3D VSP data set and the second 3D VSP data set within the common region 115 to generate a combined 3D VSP data set that includes the common region 115. As will be more fully described below, the methods generally contemplate combining the data from 3D VSP data sets within the common region, or using one data set preferentially over the other within the common region, to thereby provide 3D VSP data within the common region. However, when the first region and the second region do not include data representative of an overlapping region, then the methods described herein allow for extrapolating data from the first 3D VSP data set and the second 3D VSP data set to provide continuity in the region where no common data is available.

In a first example, the method of the present invention includes providing a first data set representative of a first 3D VSP of a first region (e.g., region 110) of a subterranean formation (e.g., 10, FIG. 1), and providing a second data set representative of a second 3D VSP of a second region (e.g., region 120) of the subterranean formation. The first data set and the second data set define a common region (115, FIG. 2) of the subterranean formation. The first data set and the second data set are merged within the common region to produce a third data set representative of a third 3D VSP of the first and second regions of the subterranean formation. The act of merging the data sets within the common region can be performed in different manners, as will be described more fully below. The third data set can then be stored on computer readable media, and can also be displayed visually either by printing or display using a computer graphics program.

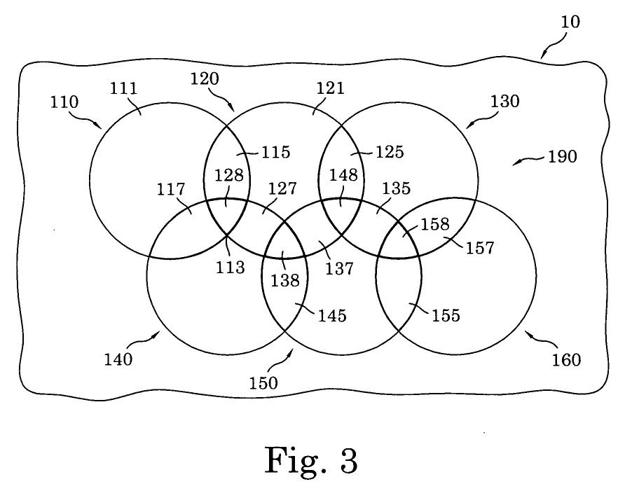

The method can also include merging three or more 3D VSP data sets. Specifically, turning now to FIG. 3, a schematic plan view depicts a plurality of regions of a subterranean formation 10 which can be imaged using vertical seismic profiling, and thereafter combined according to the methods described herein to provide a combined 3D VSP regional view of the formation. FIG. 3 depicts six regions 110, 120, 130, 140, 150 and 160 in a plan view. Each region is overlapped by at least two other regions. The common regions between adjacent regions include portions having an overlap of two regions (e.g., common region 115 between regions 110 and 120, common region 117 between region 110 and 140, and so on for common regions 125, 127, 137, 135 and 157). Common region 115 is defined by the intersecting circular arcs of regions 110 and 120, and so on for the other common regions of two overlapping 3D VSP data sets. In addition to these common regions where two regions (or 3D VSP data sets) overlap, the common regions include portions having an overlap of three regions (e.g., common region 128 which includes an overlap of regions 110, 120 and 140, and so on for common regions 138, 148 and 158). It will be appreciated that the common regions having three overlapping 3D VSP data sets can also be defined as an overlap of two common regions consisting of an overlap of two 3D VSP data sets. For example, common region 128 essentially consists of overlapping portions of common regions 115 and 117. As can be appreciated, when the 3D VSP data sets representing all of the regions 110, 120, 130, 140, 150 and 160 are merged as depicted in FIG. 3, then an overall 3D VSP 190 of the subterranean formation can be developed.

When merging common regions of three overlapping 3D VSP data sets (common regions 128, 138, 148 and 158 of FIG. 3), different approaches can be used, as described more fully below.

Before describing specific embodiments of the method, it should be mentioned that 3D VSP data can include many different kinds of data. For example, 3D VSP data can include information on shear waves (S-waves), compression waves (P-waves), and converted modes between each. Accordingly, a first embodiment for merging the 3D VSP data in the common region can be used on all types of data, or it can be used on only one type of data, with a second embodiment used on the other types of data. The decision on which embodiment to use to merge the data will be made by the user depending on which particular features the user wishes to enhance (or suppress) in the final merged 3D VSPs.

### First Embodiment: Migrate Separate VSP Data Sets, then Merge the Data Sets

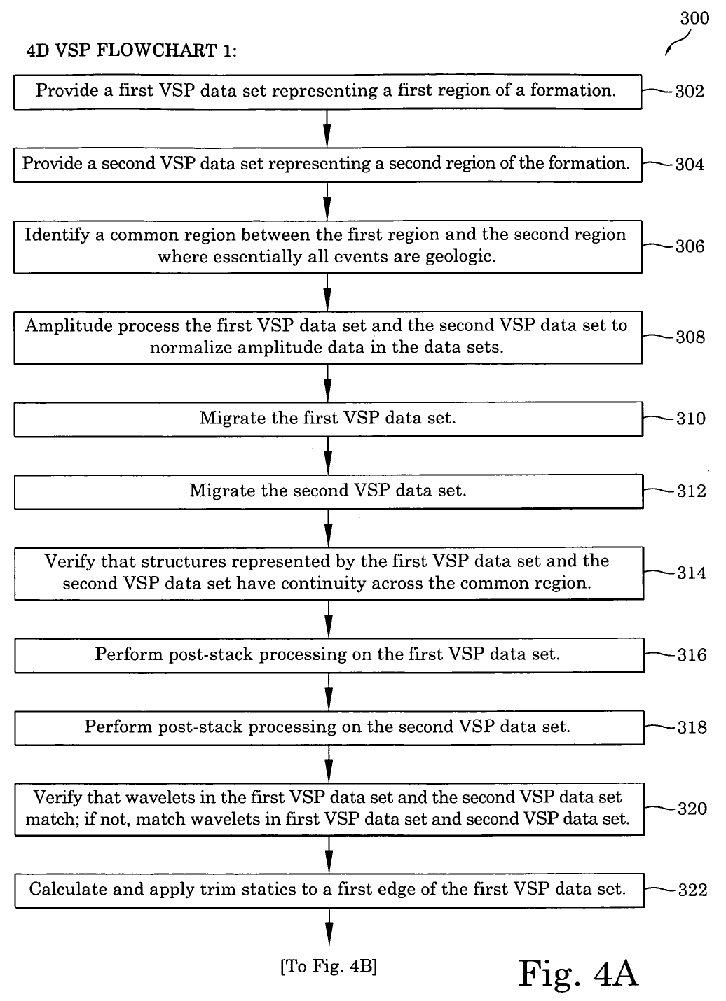

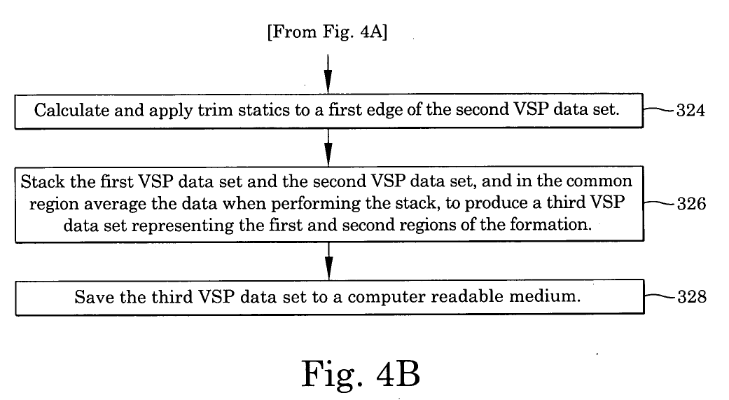

In a first embodiment two (or more) 3D VSP data sets are merged as generally described above with respect to FIGS. 2 and 3. More specifically, the data in each 3D VSP data set is first migrated, and then the data sets are merged. One specific example is provided for in FIGS. 4A and 4B, which together are a flowchart 300 depicting steps that can be executed to perform the method. The steps depicted in the flowchart 300 can be performed on one or more computers as computer executable program steps. It will be appreciated that the flowchart 300 is exemplary only, and that not all steps depicted are necessary to carry out the method. Further, certain steps depicted can be performed in different order, and additional steps can be added, all within the scope of the overall method.

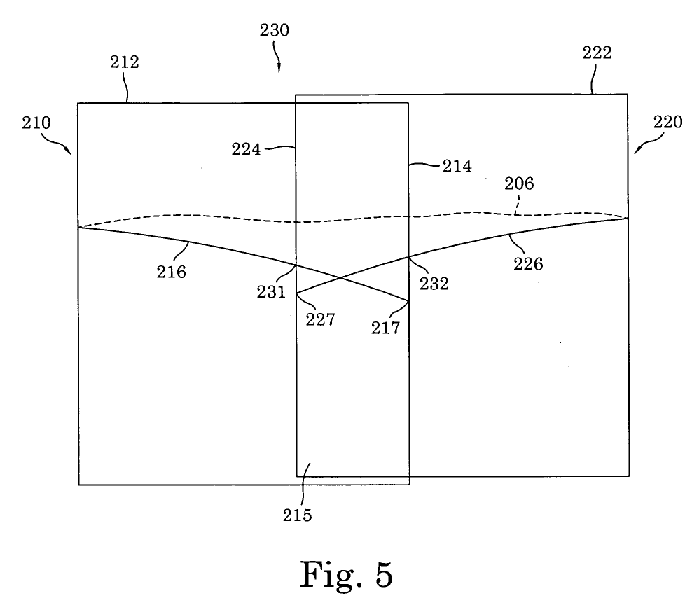

The flowchart 300 of FIGS. 4A and 4B will be described in conjunction with FIGS. 2 and 5. FIG. 5 is a schematic diagram depicting graphical representations of two 3D VSP data sets. A first data set 210 is representative of a 3D VSP of a first region (e.g., region 110, FIG. 2) of a subterranean formation, while a second data set 220 is representative of a 3D VSP of a second region (e.g., region 120, FIG. 2) of the subterranean formation. While the data sets 210 and 220 are depicted in only two dimensions, it is understood that they can be three dimensional (3D) data sets, with only a single side shown in FIG. 5. The first data set 210 and the second data set 220 have overlapping data 215 which is representative of 3D VSP data in the common region 115 of FIG. 2. The overlapping data is bounded by first data set edge 214 (represented by first data set edge data) and second data set edge 224 (represented by first data set edge data). After the first data set 210 and the second data set 220 are merged, the result is a third data set 230 that includes data in the overlapping or common region (data 215), as well as data outside of the overlapping region.

FIG. 5 also depicts an event 206 (which can be a geologic feature such as an interface between two different rock types) which can be represented by (and imaged by) the third data set 230. In the first data set 210 the event 206 is represented by data which can image line 216 (terminating at endpoint 217 in the region of common data 215), while in the second data set 220 the event 206 is represented by data which can image line 226 (terminating at endpoint 227 in the region of common data 215). It will be appreciated that components 216 and 226 of the event 206 represent unmigrated data. This subject will be discussed further below.

Turning now to FIG. 4A, in step 302 a first 3D VSP data set (e.g., 210, FIG. 5) representing a first region (e.g., 110, FIG. 2) of a formation (e.g., 10, FIGS. 1 and 2) is provided. In step 304 a second 3D VSP data set (e.g., 220, FIG. 5) representing a second region (e.g., 120, FIG. 2) of the formation is provided. The first and second data sets can be provided as digital data which can be read by a computer off of computer readable media. The data sets can be 3D VSP data sets.

In step 306, a common region (115, FIG. 2) between the first region 110 and the second region 120 is identified, where essentially all events are derived from geologic features within the common region. The data representative of this region are then identified and characterized (e.g., data 215, FIG. 5). This step helps to ensure that the two data sets (and thus regions) can be matched to provide data (and an image) having continuity across the common region. For example, the first data set can include data representing an event that is not geologic, but is rather an artifact or an anomaly, and which is not part of the second data set. Conversely, the first data set can include an event that is geologic but that could only be imaged from the geometry of the first survey and not the second. In these cases it is not possible to provide continuity of this event across the common region and into the second data set. Methods for determining whether an even is geologic or not include looking for a corresponding event in both data sets, and preparing simulated volumes modeling expected events from the geology and seismic recording geometry in each. Essentially, each event which is to be imaged across both data sets should have corresponding (but not identical, of course) data in both data sets. Known statistical methods can thus be used to identify and match events in both data sets. Unmatched events are possible candidates for artifacts and anomalies. If non-geologic events are identified, the common region can be reselected to avoid such events. Alternately, the data representing the identified non-geologic events can be ignored during the data merging process. If the non-corresponding events are geologic in nature, then the data set that includes the events can be included in the common region.

In step 308 the first 3D VSP data set and the second 3D VSP data set are amplitude processed to normalize amplitude data in the first and second data sets. As will be appreciated, for a variety of reasons amplitude data in each of the data sets may be independently scaled, depending on conditions at the time each 3D VSP survey is conducted. For example, soil moisture conditions, variations in the strength of the source, and general instrument calibration differences between surveys can introduce amplitude differences for what should otherwise be the same amplitude signal. Amplitude processing can be performed by establishing one amplitude value for a common data point, and then using this value as the value to calibrate the other amplitude data in one data set or the other. Amplitude normalization provides for a continuity of signal strength (represented by the data) between the two data sets after merging.

In step 310 the first 3D VSP data set is migrated, and in step 312 the second 3D VSP data set is migrated. Data migration techniques are well known and are generally used to accurately position reflection events in 3D subsurface space, and remove the artificial curvature of an event from the data (see, for example, how lines 126 and 226 in FIG. 5 curve in opposite directions and overlap, yet following migration will represent a relatively horizontal and continuous event 206).

In step 314 a verification is made that structures represented by the first 3D VSP data set and the second 3D VSP data set have continuity across the common region. This is essentially a follow-up to step 306 to verify that the identified events will actually match up across the common region once the data sets are merged. This can be performed by a simple process of identifying events in each data set, and verifying that the events are (1) the same in number, and (2) match up essentially spatially.

In steps 316 and 318 any post-stack processing desired can be performed on each of the first and second data sets (individually). Examples of post-stack processing include balancing amplitudes, enhancing frequencies, filtering and deconvolution, among others. It will be appreciated that such post-stack processing can be performed on the data sets at this time, even though the data sets have been stacked, but not migrated.

In step 320 a verification is made that wavelets in the first 3D VSP data set and the second 3D VSP data set match. If the wavelets do not match, wavelet characterization and extraction can be performed on at least one data set and then applied to both data sets to enhance the probability of a match of the wavelets between the two data sets. In general, the objective of wavelet matching (and wavelet processing to accomplish the matching) is to conform the wavelets in the entire data (or, in this case, the two data sets) to a standard wavelet form. This ensures uniformity among the wavelets (i.e., the data representing the wavelets) with respect to frequency, phase, and other parameters used to characteristics the variables of the wavelets.

In step 322 trim statics are calculated and applied to the data (e.g., 214, FIG. 5) of the first data set (210), and in step 324 (FIG. 4B) trim statics are calculated and applied to the data (e.g., edge 224, FIG. 5) of the second data set (220). Trim statics are well understood in the art, and are used to remove residual moveout not resolved by the velocity model.

In step 326 the first and second data sets are merged. In the specific example provided, the first 3D VSP data set and the second 3D VSP data set are stacked, and in the common region (215, FIG. 5) the common data is averaged when performing the stack. The result is a third 3D VSP data set (230, FIG. 5) representing a third region (101, FIG. 2) consisting of the first and second regions (110, 120) of the formation. Thereafter, in step 326, the third 3D VSP data set (being the merged first and second 3D VSP data sets) can be saved onto computer readable media, presented graphically, or further processed.

In the specific example provided in FIGS. 4A and 4B the data 215 (FIG. 5) in the common region is averaged. However, the data in this common region can be combined in other ways as well. For example, the data can be interpolated across the common region, or one data set can be chosen over the other. More specifically, referring to FIG. 5, in merging data representing event 206 across the common region 215, the value of the data at point 231 in the first data set (proximate side 224 of the second data set 220) can be used as the starting value (going left to right), with the data value at point 232 in the second data set 220 (proximate side 214) being used as the ending value. The intermediate values between points 231 and 232 are calculated using weighted averages based on the data values at points 227 and 217, and the distance from edge 224 (or 214) to the point where the interpolated data value is being calculated (i.e., using traditional interpolation methods).

As discussed previously, 3D VSP data does not consist of a single data value assigned to a specific point in space, but typically includes a number of different values representing different characteristics (e.g., S-wave amplitudes, P-wave amplitudes, etc.) Accordingly, one method of merging data in the common region can be used on one kind of data, while another method for merging data in the common region can be used for another kind of data.

In addition to calculating or selecting values for data in the common region 215 based on data from the first and second data sets, data outside of the common region can also be modified during the data merging process. For example, in the case where data in the common region is calculated by averaging the data, this may result in a slight discontinuity of data at the boundaries (214, 224). One method to smooth out these discontinuities is to extrapolate data from the edges in the common region 215 into the first and second data sets to a preselected distance which will smooth out the data across the boundaries.

### Second Embodiment: Merge the Data Sets, then Migrate the Merged Data Set

In the first embodiment (described above), the data from the first 3D VSP data set and the second .3D VSP data set are first migrated separately (steps 310 and 312), and the data sets are thereafter merged (step 326). In the second embodiment (described below), the data from the first 3D VSP data set and the second 3D VSP data set are first merged, and thereafter the merged data are migrated as a single volume.

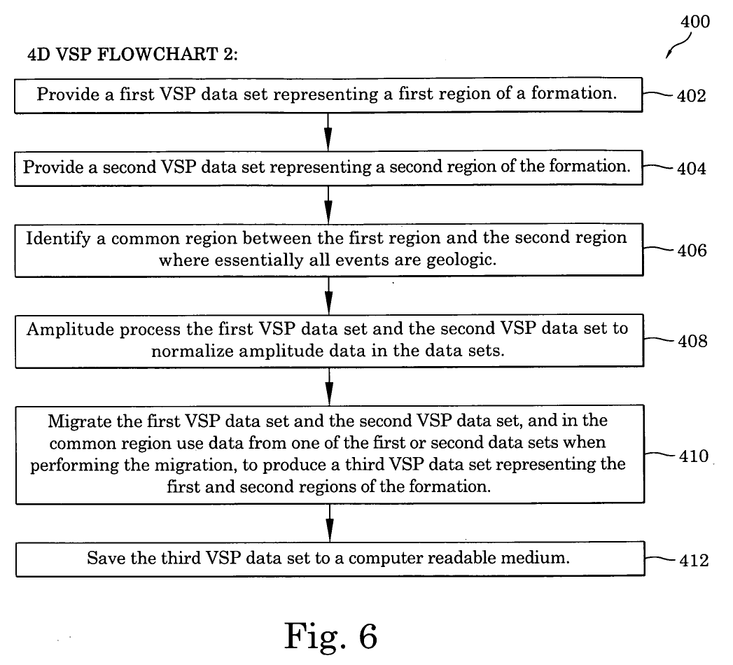

Turning now to FIG. 6, a flowchart 400 depicting a second embodiment of the method for merging 3D VSP data sets is shown. Steps 402, 404, 406 and 408 in FIG. 6 essentially correspond to steps 302, 304, 306 and 308 of the flowchart 300 of FIG. 4A. A more complete description of steps 402, 404, 406 and 408 can thus be had by reading the description above for steps 302, 304 and 306 in FIG. 4A. Generally, these steps pertain to providing the first and second 3D VSP data sets (steps 402 and 404, respectively), identifying the common region where events are essentially geologic (step 406), and amplitude processing the first and second 3D VSP data sets to normalize amplitude data (step 408).

In step 410 of flowchart 400 (FIG. 6) the first 3D VSP data set and the second 3D VSP data set are migrated, and in the common region (215, FIG. 5) data from one of the first or second data set is selected and used when performing the migration. The result is a third 3D VSP data set representing the first and second regions of the formation. Generally, the data from the non-selected data set used in the common region can be discarded. However, the data from the non-selected data set used in the common region can also be used to make subsequent corrections to the migrated data from the first data set in the common region. For example, data from the non-selected data set can be used to smooth discontinuities at the data set edges which define the common region. Thereafter, in step 412, the third 3D VSP data set (being the merged first and second 3D VSP data sets) can be saved onto computer readable media, presented graphically, or further processed.

It will be appreciated that a number of the steps shown in the flowchart 300 of FIGS. 4A and 4B can also be used in the process depicted in the flowchart 400 of FIG. 6. For example, the wavelet matching step (step 320) and the application of trim statics (step 322) can be applied to individual first and second data sets in flowchart 400 prior to the merging of the data (step 412). It will also be appreciated that trim statics can also be applied to the merged data sets following merging.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims as appropriately interpreted.

We claim:

1. A method comprising:
providing a first data set representative of a first 3D VSP of a first region of a subterranean formation;
providing a second data set representative of a second 3D VSP of a second region of the subterranean formation;
wherein the first data set and the second data set define a common region of the subterranean formation;
merging the first data set and the second data set within the common region to produce a third data set representative of a third 3D VSP of the first and second regions of the subterranean formation; and
storing the third data set on a computer readable medium.

2. The method of claim 1 wherein the second data set is obtained later in time than the first data set.

3. The method of claim 1 wherein merging the first data set and the second data set within the common region comprises averaging data from the first and second data sets which is representative of the common region.

4. The method of claim 3 wherein the first and second data sets are migrated prior to merging.

5. The method of claim 1 wherein the first data set comprises the first data set edge data, the second data set comprises second data set edge data, and the common region is defined by is defined by the first and second edge set edge data, and further wherein merging the first data set and the second data set within the common region comprises interpolating the first and second edge set edge data into the common region.

6. The method of claim 1 and further comprising, prior to merging the first data set and the second data set within the common region, verifying that the first and second data sets comprise data representative of common geologic events.

7. The method of claim 1 and further comprising, after merging the first data set and the second data set within the common region, identifying data representative of events within the first and second regions and verifying essential continuity of data representative of the events across the common region.

8. The method of claim 1 and wherein merging the first data set and the second data set within the common region comprises selecting data from one of the first or second data sets to be used as data representative of the common region.

9. The method of claim 8 wherein the data representative of the common region is migrated after the merging.

10. The method of claim 1 further comprising, following the merging of the first data set and the second data set within the common region, extrapolating data representative of the common region into the first data set outside of the common region.

11. The method of claim 1 further comprising, following the merging of the first data set and the second data set within the common region, extrapolating data representative of the common region into a third region not represented by either the first or second data sets.

12. The method of claim 1 further comprising providing a fourth data set representative of a third VSP of a third region of the subterranean formation, wherein the fourth data set defines at least a portion of the common region, and further comprising merging the fourth data set and the third data set within the portion of the common region to produce a fifth data set representative of a fourth VSP of the first, second and third regions of the subterranean formation, and storing the fifth data set on a computer readable medium.

13. The method of claim 12 wherein the second data set is obtained later in time than the first data set, the fourth data set is obtained later in time than the second data set, and the fourth data set is merged with the third data set following merging of the first and second data sets.

14. A computer readable medium comprising a series of computer-executable program steps configured to perform the method of claim 1.

15. A computer readable medium comprising the third data set produced by the method of claim 1.
